(19) United States
(12) Patent Application Publication
(10) Pub. No.: US 2011/0210542 A1
(43) Pub. Date: Sep. 1, 2011

(54) Connector for Spoolable Pipe

(76) Inventors: Christopher E. Makselon, Cypress, TX (US); Chanthol Tho, Cypress, TX (US)

(21) Appl. No.: 13/032,024

(22) Filed: Feb. 22, 2011

Related U.S. Application Data
(60) Provisional application No. 61/307,102, filed on Feb. 23, 2010.

(51) Int. Cl. F16L 25/00

(52) U.S. Cl. 285/330; 285/420

(57) ABSTRACT

Connectors for use with spoolable pipe. An example embodiment includes a connector for a spoolable pipe including a segmented clamping element comprising a plurality of clamping segments, means for releasably coupling the plurality of clamping segments when positioned over an outer surface of the spoolable pipe, and a mating mandrel adapted to be at least partially positioned within a bore of the spoolable pipe such that the spoolable pipe is sealingly held between the mating mandrel and coupled clamping segments, when coupled.

### RELATED APPLICATIONS

The current application claims the benefit of U.S. Provisional Application No. 61/307,102 filed Feb. 23, 2010. The aforementioned patent application is incorporated herein by reference.

### FIELD

The present invention relates generally to the field of fluid transport, and more particularly to connectors for use with a spoolable pipe.

### BACKGROUND

Steel coiled tubing is a commonly used type of spoolable pipe in oil well operations. For example, steel coiled tubing may be used in running wireline cable down hole with well tools, such as logging tools and perforating tools. Such tubing may also be used to workover wells, to deliver various chemicals downhole and to perform other functions. Coiled tubing may offer a much faster and less expensive way to run pipe into a wellbore by eliminating the time consuming task of joining a series of pipe sections (often 30 feet each) by threaded connections to make up a pipe string that typically is up to 10,000 feet or longer.

Steel coiled tubing may use steel that exhibits high ductility (i.e., the ability to plastically deform without failure), thereby allowing it to be spooled. The spooling operation is commonly conducted while the tube is under high internal pressure, introducing combined load effects. Unfortunately, repeated spooling and use may cause fatigue damage and the steel coiled tubing can suddenly fracture and fail. The steel coiled tubing may be retired after a relatively small number of trips into a well, before any expected failure, due to the hazards of operation, such as risks to personnel and the high economic cost of down time to conduct fishing operations that result from a failure.

The cross section of steel tubing may expand during repeated use, potentially resulting in reduced wall thickness and higher bending strains with an associated reduction in the pressure carrying capability. Steel coiled tubing presently in service is generally limited to internal pressures of about 5000 psi. Higher internal pressure may significantly reduce the integrity of coiled tubing so that it can not sustain continuous flexing, severely limiting its service life. Internal pressure may range from 5,000 psi to 10,000 psi in order to perform certain well operations; for example, chemical treatment or fracturing. External pressures can also be a major load condition and can be in excess of 2500 psi. Tension and compression forces in excess of 20,000 lbf may arise from frictional forces when moving the coiled tubing through a borehole.

Many spoolable non-metallic tubular structures for transporting fluids are made as a hose. An example of such a hose is the Feucht structure disclosed in U.S. Pat. No. 3,856,052 which has longitudinal reinforcement in the side walls to permit a flexible hose to collapse preferentially in one plane. However, the vulcanized polyester cord plies used in the hose are unlikely to carry the significant compression loads or high external pressure loads often experienced in downhole applications. Hoses typically use an elastomer such as rubber to hold fiber together, but do not typically use a high modulus plastic binder such as epoxy. Hoses often are designed to bend and carry internal pressure, but are not normally subjected to high external pressure, axial compression, or tension loads. The elastomeric type material typically used in hoses often has a high elongation at break (e.g., greater than 400 percent) and the stress-strain response is so highly nonlinear, that it is common practice to define a modulus corresponding to a specified elongation. The modulus for an elastomeric material corresponding to 200 percent elongation typically ranges from 300 psi to 2000 psi, whereas the modulus of elasticity for a typical plastic matrix material used in a composite tube ranges from 100,000 psi to 500,000 psi or greater, with representative elongations at failure of 2 percent to 10 percent. Because the hoses often have a relatively low modulus and large strain to failure as compared to composite tubes, hoses may be easily collapsed to an essentially flat condition under relatively low external pressure and unable to carry high axial tension or compression loads. Though the higher elastic modulus of a plastic matrix material used in a composite tube may be sufficiently stiff to transfer loads into the fibers and thus resist high external pressure and axial tension and compression without collapse, there are challenges in building a composite tube capable of being bent to a relatively small diameter capable of carrying internal pressure and high tension and compression loads in combination with high external pressure requirements. The procedure to construct such a composite tube typically involves using complex composite mechanics engineering principles to ensure that the tube has sufficient strength.

In wellbore operations involving spoolable pipe, it is often necessary to make various connections, such as to interconnect long sections of pipe or to connect tools or other devices into or at the end of the pipe string. With steel coiled tubing, a variety of well known connecting techniques are available to handle the severe loads encountered in such operations, such as threaded connections and welded connections, which may be easily applied and meet the load requirements described.

It is desirable to provide improved connectors for a substantially non-ferrous spoolable pipe capable of being deployed and spooled under typical borehole conditions, which does not suffer from the structural limitations of steel tubing, and which is also highly resistant to chemicals. Such non-ferrous spoolable pipe may be used in a similar capacity as coiled tubing, such as carrying fluids from the surface to a downhole location to treat formations or to operate a mud motor used to drill through the formations. In addition, it may be desirable to pump devices through the spoolable pipe. Therefore, an open bore within the spoolable pipe may be needed for some operations.

### SUMMARY

In view of the foregoing, there is a need for improved connectors for use with spoolable pipe and, for example, composite spoolable pipe such as for use in line pipe, production tubing, well logging and workover operations in oil wells.

One aspect includes a connector for a spoolable pipe. The pipe includes a segmented clamping element comprising a plurality of clamping segments, means for releasably coupling the plurality of clamping segments when positioned over an outer surface of the spoolable pipe, and a mating mandrel adapted to be at least partially positioned within a bore of the spoolable pipe such that the spoolable pipe is sealingly held between the mating mandrel and clamping segments, when coupled.

In one embodiment, the mating surfaces of the plurality of clamping segments include abutting tongue and groove surfaces. In other embodiments, the segmented clamping element may include two or three clamping segments. In alternative embodiments, the segmented clamping element may have a greater number of clamping segments.

In one embodiment, an inner surface of at least one of the plurality of clamping segments includes a plurality of teeth for engaging the outer surface of the spoolable pipe. In another embodiment, an inner diameter of the segmented clamping element substantially corresponds with an outer diameter of the spoolable pipe, when coupled.

The means for releasably coupling the plurality of clamping segments may include, or consist essentially of, a plurality of bolts adapted to threadably engage corresponding threaded holes in each clamping segment. Alternatively, or in addition, the means for releasably coupling the plurality of clamping segments may include at least one of a tapered wedge, a welded connection, a pinned connection, a slotted connection, a threaded connection, a magnetic connection, and/or a tube clamp.

In one embodiment, the mating mandrel may include an outer surface adapted to elastomerically seal with the inner diameter of the spoolable pipe. The outer surface of the mating mandrel may include at least one of a barbed surface, a channeled surface, an annular groove, and/or a knurled surface. The connector may include an annular seal positioned within the annular groove. In one embodiment, the mating mandrel includes a distal end adapted to extend from an end of the spoolable pipe. The distal end of the mating mandrel may include at least one of a flange face, a threaded element, and/or a weldable element.

In one embodiment, at least one of the segmented clamping element and the mating mandrel includes, or consists essentially of, at least one of a mild carbon steel, a stainless steel, and/or a metal alloy. The segmented clamping element and/or the mating mandrel may include a coating, for example to provide corrosion protection. The connector may include one or more energy conductors.

These and other objects, along with advantages and features of the present invention, will become apparent through reference to the following description, the accompanying drawings, and the claims. Furthermore, it is to be understood that the features of the various embodiments described herein are not mutually exclusive and may exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic exploded perspective view of a connector for a spoolable pipe having two clamping segments;

FIG. 2 is a schematic exploded perspective view of a connector for a spoolable pipe having three clamping segments; and

FIG. 3 is a schematic exploded perspective view of a connector for a spoolable pipe with an energy conductor.

### DETAILED DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

One embodiment disclosed herein relates to a connector system for use in connecting a spoolable pipe such as, but not limited to, a composite spoolable pipe. The system may include a segmented clamp and mating mandrel to ensure proper attachment to the pipe while maintaining a pressure seal for fluid transport. Features of the system allow it to be customizable to mate with existing end user configurations without extensive additional fabrication or processing. The system may also allow for simple installation, for example, with the use of standard hand tools.

In one embodiment, the connector includes a tongue and groove design to transfer the loads associated with gripping and sealing to the end of a spoolable pipe. External clamps for use with the system may be segmented, for example to allow for flexibility and adaptation to changes in outside diameter of the spoolable pipe. The inner diameter of the external clamp may be profiled to maximize gripping force on the outside diameter of the spoolable pipe. The external clamp may, for example, be attached using bolts which are torqued to a specific value to ensure adequate gripping forces on the pipe. The connector may be of any appropriate length, diameter, and/or thickness and, for example, may scale based on the outside diameter of the spoolable pipe to ensure adequate gripping forces.

In one embodiment, the connector includes a mandrel to seal on the inside diameter of the spoolable pipe, for example using an elastomeric seal. The mandrel may also seal on the inside diameter of the spoolable pipe using a barbed, channeled, or other surface profile finish intended to seal on the inner diameter material of the spoolable pipe. The major outside diameter of the mandrel may be kept to a minimum to allow for clearance for additional components such as flanges or fittings, and can be customized to match the nominal size of the intended end user tie-in point. In one embodiment, the termination end of the mandrel can be configured into a flange face, threaded end, weldable end, or other end user specified configuration to facilitate ease of integration into existing systems.

The connector components can be machined from materials such as, but not limited to, mild carbon steel. The connector components can also be machined from stainless steel or other alloys for added corrosion protection. Various connector components may, alternatively, or in addition, be coated for corrosion protection. In various embodiments, the connector can be made using any combination of suitable materials to maximize corrosion protection, maximize strength, and/or meet other end user requirements.

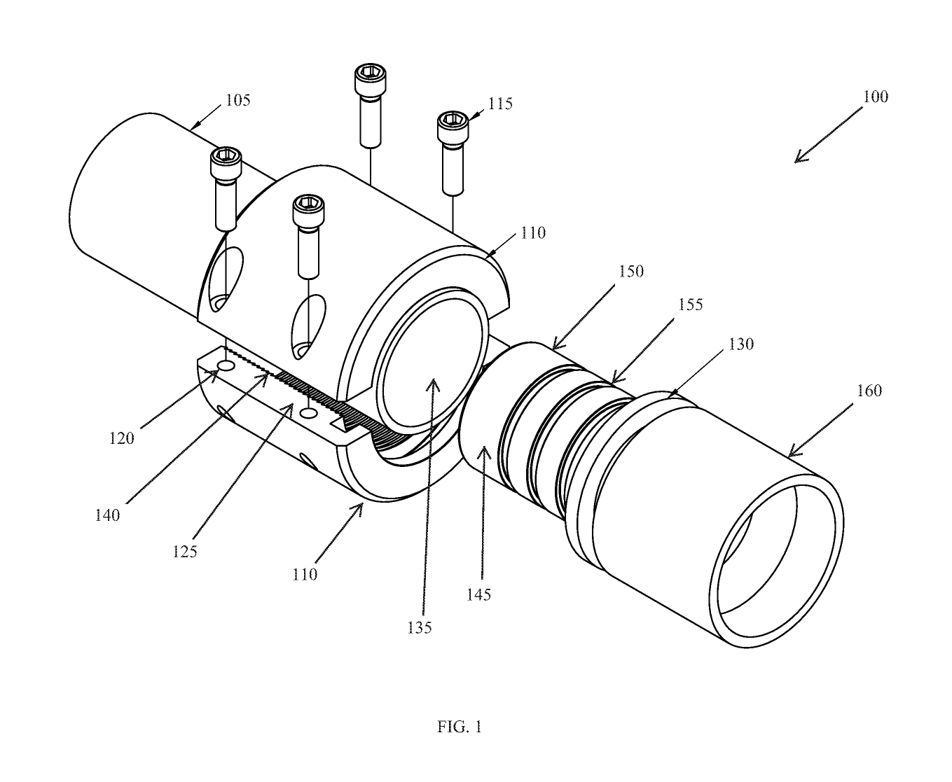

An example connector 100 for connecting to a spoolable pipe 105 is shown in FIG. 1. In this embodiment, the connector 100 includes a segmented clamping element including a plurality of clamping segments 110. The connector 100 may also include means, such as, but not limited to, one or more bolts 115 for releasably coupling the plurality of clamping segments 110 when positioned over an outer surface of the spoolable pipe 105. The bolts 115 may, for example, be adapted to threadably engage corresponding threaded holes 120 in a mating surface 125 of an adjoining clamping segment 110. In alternative embodiments, the clamping segments 110 can be releasably coupled together through tapered wedges, welded connections, pinned connections, slotted connections, threaded connections, magnetic connections, and/or tube clamps in addition to, or instead of, the use of threaded connections. The connector 100 may also include a mating mandrel 130 for positioning within a bore 135 of the spoolable pipe 105. As a result, the spoolable pipe 105 may be sealingly held between the mating mandrel 130 and the clamping segments 110, when coupled. The mating mandrel 130 may have a hollow interior bore, thereby allowing fluid flowing to and from the spoolable pipe 105 to flow freely through the interior of the mating mandrel 130 with minimal or no restriction. Mating surfaces 125 of adjoining clamping segments 110 may include mating elements such as, but not limited to, abutting tongue and groove surfaces, to assist in accurately mating the adjoining surfaces of the clamping segments 110.

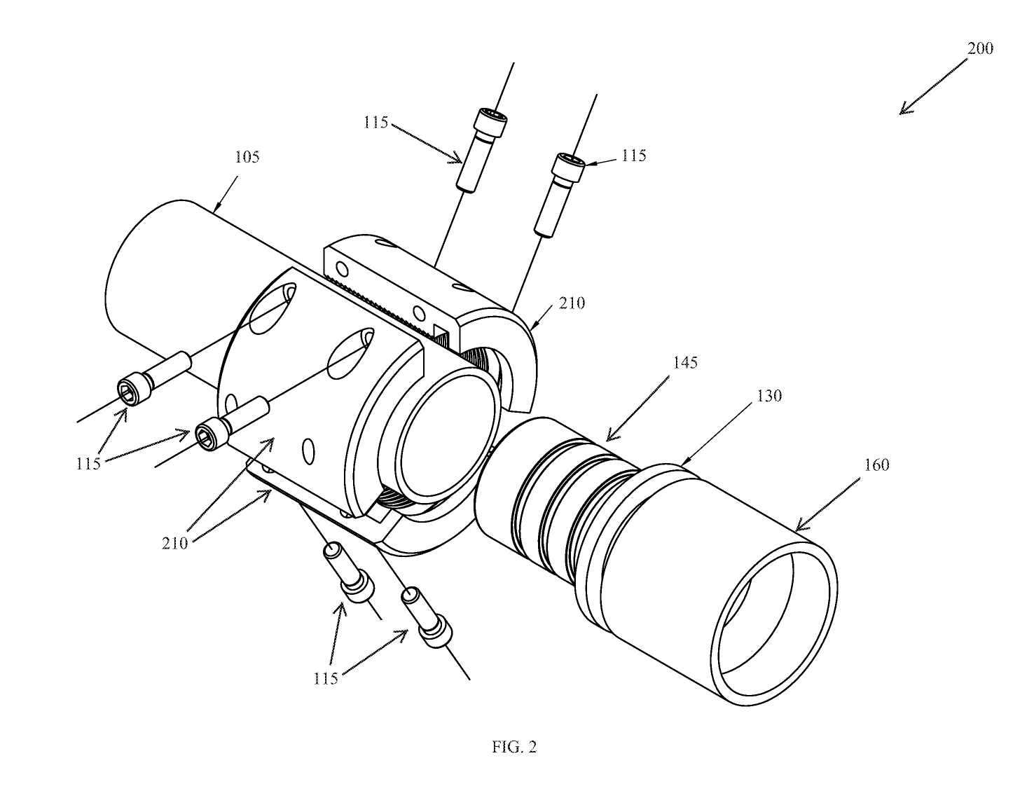

In one embodiment, as shown in FIG. 1, the connector 100 includes two separate clamping segments 110, each spanning approximately 180° around the spoolable pipe 105. In alternative embodiments, the connector 100 may include a greater number of clamping segments 110, such as three, four, or more separate segments. These segments may each span approximately the same circumferential distance of the spoolable pipe 105 diameter, or be configured to span different circumferential distances, as appropriate. An example connector 200 including three separate clamping segments 210, each spanning approximately 120° around the spoolable pipe 105, is shown in FIG. 2.

In various embodiments, the inner surface of at least one of the plurality of clamping segments 110 may include one or more surface features for engaging the outer surface of the spoolable pipe 105 to assist in sealingly gripping the spoolable pipe 105. The surface features may, for example, include one or more teeth 140 extending circumferentially around the inner surface of one or more clamping segments 110, or portions thereof. Alternatively, the surface features may include barbs, channels, annular grooves (e.g. with annular sealing elements extending therein), knurling, and/or any other appropriate gripping feature instead of, or in addition to, teeth 140. In an alternative embodiment, the inner surface of one or more clamping segments 110, or a portion thereof, may be substantially smooth, with the compression pressure between the clamping segments 110 and the mating mandrel 130 being sufficient to grip the spoolable pipe 105. In one embodiment, an inner diameter of the coupled segmented clamping segments 110 substantially corresponds with an outer diameter of the spoolable pipe 105. In an alternative embodiment, the segmented clamping segments 110 may be configured such that their inner diameter, when coupled, is slightly less than the outer diameter of the spoolable pipe 105 to which they are to be coupled. In a further alternative embodiment, the segmented clamping segments 110 may be configured such that their inner diameter, when coupled, is slightly greater than the outer diameter of the spoolable pipe 105 to which they are to be coupled. In this embodiment, an additional element may be placed between the clamping segments 110 and the spoolable pipe 105 to assist in gripping the spoolable pipe 105.

In one embodiment, the mating mandrel 130 includes a proximal end 145 having an outer surface 150 adapted to elastomerically seal with the inner diameter of the spoolable pipe 105. For example, in another embodiment a connector 100 may include a mating mandrel 130 having an outer surface 150 having one or more surface features such as, but not limited to, teeth, barbs, channels, annular grooves (e.g. with annular sealing elements extending therein), knurling, and/or any other appropriate gripping feature to assist in sealingly gripping the inner surface of the spoolable pipe 105. A mating mandrel 130 with an outer surface 150 having a plurality of annular grooves 155 is shown in FIG. 1. In one embodiment, an annular seal may be positioned within one or more of the annular grooves 155 to assist in ensuring an elastomeric seal between the mating mandrel 130 and the spoolable pipe 105.

In one embodiment of a connector 100, a mating mandrel 130 may include a distal end 160 which extends from an end of the spoolable pipe 105 when the mating mandrel 130 is inserted into the spoolable pipe 105. This distal end 160 may be used, for example, to connect to an end user tie-in point, another spoolable pipe, a pipe fitting, or to another element such as, but not limited to, a pump, a flow regulator and/or splitter, a drillhead, or any other appropriate element or device. In various embodiments, the distal end 160 may include at least one of a flange face, a threaded element, and/or a weldable element, thereby allowing the mating mandrel 130 to be sealingly connected, for example, to another pipe or pipe fitting.

In one example embodiment, the distal end 160 includes an element for insertion into an interior of another pipe, such that the clamping segments 110 may extend over both the proximal end 145 and distal end 160 to allow two separate sections of spoolable pipe to be coupled together. Alternatively, separate clamping segments 110 may be used to clamp over the proximal end 145 and distal end 160.

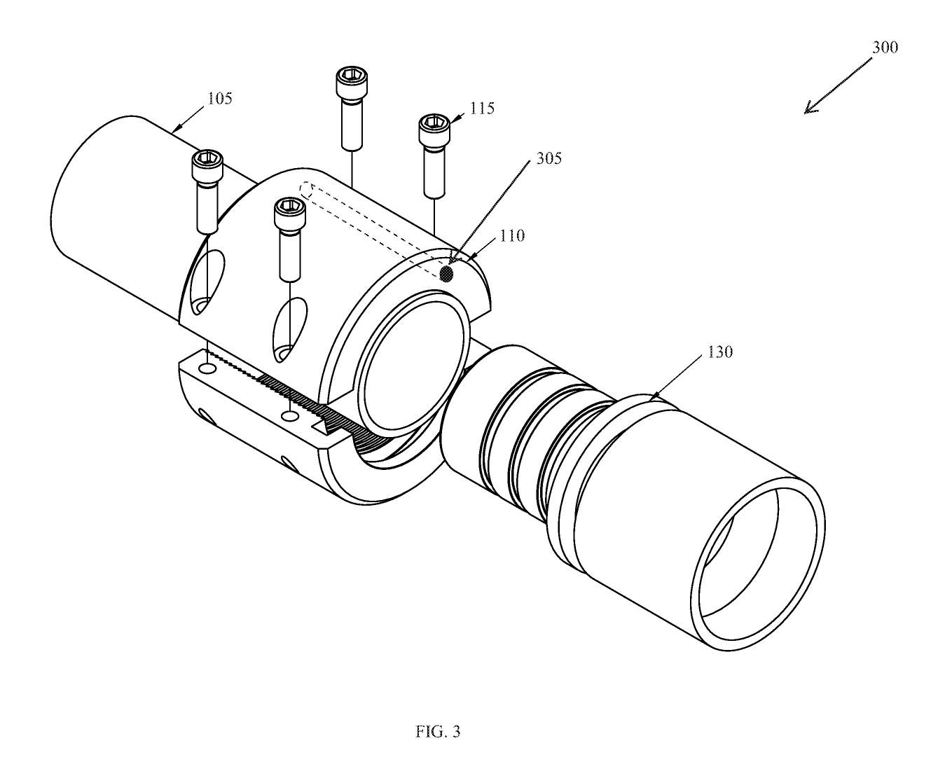

In various embodiments, the spoolable pipe 105 may include one or more energy conductors (e.g. power and/or data conductors) to provide power to, and provide communication with, sensors, monitoring equipment, pumps, and/or other powered elements located along various portions of the spoolable pipe 105. For embodiments including spoolable pipes 105 having one or more energy conductors, the connector may include one or more energy conducting elements to provide for energy conduction through the connector from the energy conductor in or around the spoolable pipe 105. An example connector 300 including an energy conductor 305 is shown in FIG. 3. In various embodiments, energy conductors 305 may be embedded within one or more of the clamping segments 110, be located between a clamping segment 110 and the spoolable pipe 105, when coupled, or located to the exterior of one or more clamping segments 110. In various embodiments, energy conductors may be embedded within one or more layers of the spoolable pipe 105, extend along the annulus between various layers of the spoolable pipe 105, and/or extend within the interior of the spoolable pipe 105 or outside the exterior of the spoolable pipe 105.

In one embodiment, the connector 300 may include a device such as, but not limited to, a measurement device, a communication device, a pumping element, and/or a valve. Power to the device and/or communication with the device may be conducted through the one or more energy conductors 305. Example measurement devices for monitoring one or more properties of a fluid through the interior of the connector 300 include, but are not limited to, a flow meter, a pressure meter, a temperature meter, a stress meter, a strain gauge, and/or a chemical composition measuring device.

In various embodiments, the connectors described herein, or components thereof (e.g., the segmented clamping element and/or mating mandrel) may be constructed from materials such as, but not limited to, mild carbon steel, stainless steel, and/or metal alloy. In an alternative embodiment, any material having the required strength, machinability, and/or corrosion properties may be used for certain components of the connectors. In one embodiment, a connector, or components thereof (e.g., the segmented clamping elements and/or mating mandrel) may be provided with a coating to provide corrosion protection. In an alternative embodiment, components of the connector are manufactured entirely from materials providing the required corrosion protection, thereby eliminating the need for a separate coating.

In various embodiments of a connector 100, the spoolable pipe 105 may include, or consist essentially of, a single continuous spoolable tube, or a plurality of connected spoolable tubing sections. The spoolable tube may, for example, be a composite tube comprising a plurality of layers. An example spoolable pipe 105 in accordance with one embodiment of a connector 100 may include a multi-layered spoolable tube including layers such as, but not limited to, an internal barrier layer, one or more reinforcing layers, an abrasion resistant layer, and/or an external/outer protective layer

Example internal pressure barrier layers can, for example, include a polymer, a thermoset plastic, a thermoplastic, an elastomer, a rubber, a co-polymer, and/or a composite. The composite can include a filled polymer and a nano-composite, a polymer/metallic composite, and/or a metal (e.g., steel, copper, and/or stainless steel). Accordingly, an internal pressure barrier can include one or more of a high density polyethylene (HDPE), a cross-linked polyethylene (PEX), a polyvinylidene fluoride (PVDF), a polyamide, polyethylene terphthalate, polyphenylene sulfide and/or a polypropylene.

Exemplary reinforcing layers may include, for example, one or more composite reinforcing layers. In one embodiment, the reinforcing layers can include fibers having a cross-wound and/or at least a partially helical orientation relative to the longitudinal axis of the spoolable pipe. Exemplary fibers include, but are not limited to, graphite, KEVLAR, fiberglass, boron, polyester fibers, polymer fibers, mineral based fibers such as basalt fibers, and aramid. For example, fibers can include glass fibers that comprise e-cr glass, Advantex®, s-glass, d-glass, or a corrosion resistant glass. The reinforcing layer(s) can be formed of a number of plies of fibers, each ply including fibers.

In some embodiments, the abrasion resistant layer may include a polymer. Such abrasion resistant layers can include a tape or coating or other abrasion resistant material, such as a polymer. Polymers may include polyethylene such as, for example, high-density polyethylene and cross-linked polyethylene, polyvinylidene fluoride, polyamide, polypropylene, terphthalates such as polyethylene therphthalate, and polyphenylene sulfide. For example, the abrasion resistant layer may include a polymeric tape that includes one or more polymers such as a polyester, a polyethylene, cross-linked polyethylene, polypropylene, polyethylene terphthalate, high-density polypropylene, polyamide, polyvinylidene fluoride, polyamide, and an elastomer.

Exemplary external layers can bond to a reinforcing layer(s), and in some embodiments, also bond to an internal pressure barrier. In other embodiments, the external layer is substantially unbonded to one or more of the reinforcing layer(s), or substantially unbonded to one or more plies of the reinforcing layer(s). The external layer may be partially bonded to one or more other layers of the pipe. The external layer(s) can provide wear resistance and impact resistance. For example, the external layer can provide abrasion resistance and wear resistance by forming an outer surface to the spoolable pipe that has a low coefficient of friction thereby reducing the wear on the reinforcing layers from external abrasion. Further, the external layer can provide a seamless layer to, for example, hold the inner layers of a coiled spoolable pipe together. The external layer can be formed of a filled or unfilled polymeric layer. Alternatively, the external layer can be formed of a fiber, such as aramid or glass, with or without a matrix. Accordingly, the external layer can be a polymer, thermoset plastic, a thermoplastic, an elastomer, a rubber, a co-polymer, and/or a composite, where the composite includes a filled polymer and a nano-composite, a polymer/metallic composite, and/or a metal. In some embodiments, the external layer(s) can include one or more of high density polyethylene (HDPE), a cross-linked polyethylene (PEX), a polyvinylidene fluoride (PVDF), a polyamide, polyethylene terphthalate, polyphenylene sulfide and/or a polypropylene.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention.

The terms “a” and “an” and “the” used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A connector for a spoolable pipe, comprising:
a segmented clamping element comprising a plurality of clamping segments;
means for releasably coupling the plurality of clamping segments when positioned over an outer surface of the spoolable pipe; and
a mating mandrel adapted to be at least partially positioned within a bore of the spoolable pipe such that the spoolable pipe is sealingly held between the mating mandrel and clamping segments, when coupled.

2. The connector of claim 1, wherein the mating surfaces of the plurality of clamping segments comprise abutting tongue and groove surfaces.

3. The connector of claim 1, wherein the segmented clamping element comprises three clamping segments.

4. The connector of claim 1, wherein the segmented clamping element comprises two clamping segments.

5. The connector of claim 1, wherein an inner surface of at least one of the plurality of clamping segments comprises a plurality of teeth for engaging the outer surface of the spoolable pipe.

6. The connector of claim 1, wherein an inner diameter of the segmented clamping element substantially corresponds with an outer diameter of the spoolable pipe, when coupled.

7. The connector of claim 1, wherein the means for releasably coupling the plurality of clamping segments comprises a plurality of bolts adapted to threadably engage corresponding threaded holes in each clamping segment.

8. The connector of claim 1, wherein the means for releasably coupling the plurality of clamping segments comprises at least one of a tapered wedge, a welded connection, a pinned connection, a slotted connection, a threaded connection, a magnetic connection, and a tube clamp.

9. The connector of claim 1, wherein the mating mandrel comprises an outer surface adapted to elastomerically seal with the inner diameter of the spoolable pipe.

10. The connector of claim 9, wherein the outer surface of the mating mandrel comprises at least one of a barbed surface, a channeled surface, an annular groove, and a knurled surface.

11. The connector of claim 10, further comprising an annular seal positioned within the annular groove.

12. The connector of claim 1, wherein the mating mandrel comprises a distal end adapted to extend from an end of the spoolable pipe.

13. The connector of claim 12, wherein the distal end of the mating mandrel comprises at least one of a flange face, a threaded element, and a weldable element.

14. The connector of claim 1, wherein at least one of the segmented clamping element and the mating mandrel comprises at least one of a mild carbon steel, a stainless steel, and a metal alloy.

15. The connector of claim 1, wherein at least one of the segmented clamping element and the mating mandrel comprises a coating to provide corrosion protection.

16. The connector of claim 1, further comprising an energy conductor.
